(19) United States
(12) Patent Application Publication
(10) Pub. No.: US 2025/0060326 A1
(43) Pub. Date: Feb. 20, 2025

(54) THERMAL ANALYSIS DEVICE

(71) Applicant: HITACHI HIGH-TECH SCIENCE CORPORATION, Tokyo (JP)

(72) Inventor: Kengo KOBAYASHI, Tokyo (JP)

(21) Appl. No.: 18/799,464

(22) Filed: Aug. 9, 2024

(30) Foreign Application Priority Data
Aug. 14, 2023 (JP) 2023-131785

(51) Int. Cl. G01N 25/00

(52) U.S. Cl. CPC G01N 25/00

(57) ABSTRACT

Disclosed is a thermal analysis device including a probe for applying a load to a sample S, a force generator for generating and applying a force to the probe, displacement detectors for detecting the displacement of the probe to measure the mechanical properties of the sample, a force signal generator for generating a force signal to activate the force generator, a load detector for detecting a load applied to the sample, and furnaces for heating the sample. The force signal generator includes a digital signal generator that generates a digital signal of the force signal, multiple D/A converters that convert the digital signals into analog signals, and multiple amplifiers that amplify each of the analog signals output from the respective D/A converters by different amplification factors. The force signal generator outputs the analog signal amplified by at least one of the multiple amplifiers as the force signal.

### CROSS REFERENCE TO RELATED APPLICATION

The present application claims priority to Japanese Patent Application No. 2023-131785, filed Aug. 14, 2023, the entire contents of which is incorporated herein for all purposes by this reference.

### BACKGROUND OF THE DISCLOSURE

### 1. Field of the Disclosure

The present disclosure relates to a thermal analysis device that measures the thermal behavior of a sample.

### 2. Description of the Related Art

Conventionally, as a method of evaluating the temperature characteristics of a sample, a method called thermal analysis is used in which the sample is heated, and temperature-dependent thermal behavior (physical changes) of the measurement sample are measured. Thermal analysis is defined in JIS 0129:2005 standard “General Rules

for Thermal Analysis” as that all methods of measuring the physical properties of a measurement target (measurement sample) while controlling the temperature of the measurement sample in a programmed manner are called thermal analysis. There are five commonly used thermal analysis methods: (1) differential thermal analysis (DTA) for detecting temperature (temperature difference); (2) differential scanning calorimetry (DSC) for detecting thermal flow difference; (3) thermal gravimetry (TG) for detecting mass (weight change); (4) thermomechanical analysis (TMA) for detecting mechanical properties; and (5) dynamic viscoelasticity measurement (DMA).

Among these, thermomechanical analysis (TMA) and dynamic viscoelasticity measurement (DMA) apply a load to a sample with a probe and detect the shape change of the sample by measuring the displacement of the probe (see, for example, Patent Literatures 1 and 2). These allow the elastic modulus and expansion coefficient of a sample to be measured as a function of temperature or time.

For example, a dynamic viscoelasticity measurement (DMA) device applies stress or strain that varies (oscillates) over time to a sample and measures the resulting strain or stress in the sample to determine the mechanical properties (elastic modulus) of the sample.

Here, taking a dynamic viscoelasticity measurement (DMA) device as an example, the probe load (force) is generated as described below. First, an AC signal such as a sine wave, square wave or triangular wave, which is a digital signal output from an AC generator, is converted into an analog signal by a D/A converter, and then the amplitude of the analog signal is adjusted by an amplifier and then input as a current to the coil of a force generator.

As a result, an AC force is generated by electromagnetic cooperation between the coil and a magnet provided around the coil, and this AC force is applied to the sample via the probe.

### LITERATURE OF RELATED ART

### Patent Literature

[Patent Literature 1] Japanese Patent Application Publication No. H6-123722
[Patent Literature 2] Japanese Patent Application Publication No. H6-160269

### SUMMARY OF THE DISCLOSURE

The relationship between the maximum load that can be applied to a sample and a load resolution, which is the minimum load that can be applied to a sample, in a dynamic viscoelasticity measurement system or thermomechanical analysis system is as described below.

For example, when the maximum load is set to ±10 N in a force generator, a D/A converter with a digital resolution of 16 bits (two to the power of 16) would give “a load resolution=20 N (+/−10 N)/16 bits=20 N/(2¹⁶)=0.305 mN”.

In recent years, the development of lightweight and high elastic modulus materials such as carbon fiber composites has been progressing, and in the dynamic viscoelasticity measurement and thermal analysis such as thermo-mechanical analysis of such high elastic modulus samples, the maximum load to be applied to a sample is required to be increased.

However, as the maximum load is increased, the load resolution also increases proportionally, as described above, and the measurement accuracy at low loads near the load resolution decreases. On the other hand, when the digital resolution of the D/A converter is increased, theoretically, the load resolution will decrease.

However, a 24-bit D/A converter would be costly.

Thus, it is difficult in practice to accurately measure materials with high to low elastic modulus with a single thermal analysis device.

The present disclosure has been made to solve the above problems, and an object of the present disclosure is to provide a thermal analysis device capable of measuring materials with a wide range of elastic modulus from high to low with high accuracy.

In order to achieve the above-mentioned object, the thermal analysis device of the present disclosure includes: a probe extending axially, one end side of the probe contacting a sample directly or indirectly to apply a load to the sample; a force generator provided at another end side of the probe and generating a force in an axial direction of the probe; a displacement detector that detects a displacement in the axial direction of the probe to measure a mechanical property of the sample; a force signal generator that generates a force signal to activate the force generator; a load detector that detects a load applied to the sample; and a furnace for heating the sample, in which the force signal generator includes a digital signal generator that generates a digital signal of the force signal, a plurality of D/A converters that convert the digital signal into an analog signal, and a plurality of amplifiers that amplify each of the analog signals output from the respective D/A converters by different amplification factors, respectively, and the force signal generator outputs the analog signal amplified by at least one of the plurality of amplifiers as the force signal.

With this thermal analysis device, the plurality of amplifiers can amplify each of the analog signals output from the respective D/A converters by different amplification factors. This allows the maximum load that can be applied to the sample to be varied, and different load resolutions can be set without changing the digital resolution of the D/A converter.

As a result, it is possible to accurately measure both high and low elastic modulus materials.

In the thermal analysis device of the present disclosure, a difference in the amplification factor of each of the plurality of amplifiers may be greater than or equal to 2 times.

With this thermal analysis device, the maximum load that can be applied to the sample can be varied significantly due to the large amplification factor difference between each of the plurality of amplifiers.

The thermal analysis device may include a plurality of digital signal generators, each of which generating a different digital signal, and comprises a plurality of the D/A converters and a plurality of the amplifiers for each of the plurality of digital signal generators.

With this thermal analysis device, the plurality of digital signal generators can generate different digital signals, so that, for example, one of the digital signal generators can apply a DC force that is constant over time as tension to the sample.

In the thermal analysis device of the present disclosure, the different digital signals may include an AC signal that oscillates over time and a DC signal that is constant over time.

According to the present disclosure, it is possible to obtain a thermal analysis device that can accurately measure materials with high to low elastic modulus.

### BRIEF DESCRIPTION OF THE DRAWINGS

FIG. 1 is a view illustrating the construction of a thermal analysis device according to a first embodiment of the present disclosure;

FIG. 2 is a view illustrating load resolutions for different amplification factors of an amplifier; and

FIG. 3 is a view illustrating the construction of a thermal analysis device according to a second embodiment of the present disclosure.

### DESCRIPTION OF THE PREFERRED EMBODIMENTS

Hereinafter, embodiments of the present disclosure will be described with reference to the accompanying drawings.

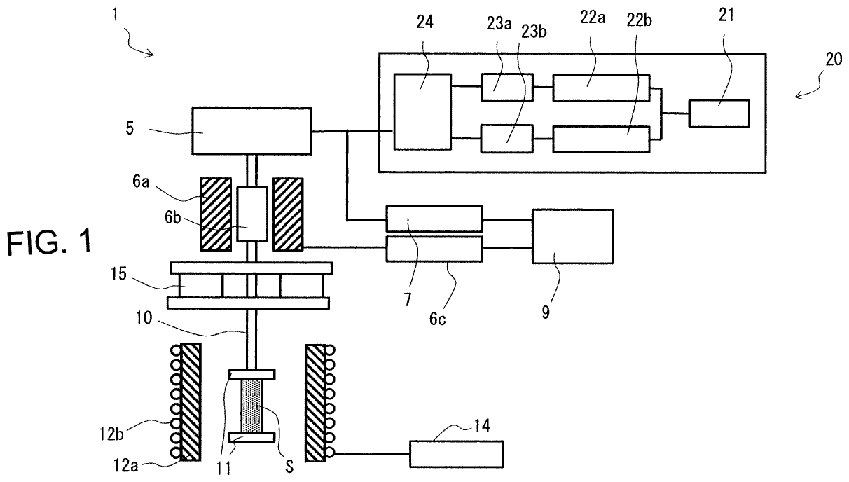

FIG. 1 is a view illustrating the construction of a thermal analysis (dynamic viscoelasticity measurement) device according to a first embodiment of the present disclosure.

A thermal analysis device 1 is equipped with a rod-shaped probe 10 extending in the axial direction, a force generator 5 that generates a force in the axial direction of the probe 10, displacement detectors 6a, 6b, and 6c that detect displacement in the axial direction of the probe 10, a force signal generator 20, a load detector 7 that detects a load applied to the sample S, and furnaces 12a and 12b for heating the sample S.

Ends of the sample S in the vertical direction are fixedly held by a sample holding member 11. One end (upper end in FIG. 1) of the sample holding member 11 is fixed to one end (lower end in FIG. 1) of the probe 10, and the probe 10 is supported by a probe support 15 in a manner to be movable in the axial direction.

With this construction, one end of the probe 10 comes into indirect contact with the sample S via the sample holding member 11 and is configured to be able to apply a load to the sample S.

Meanwhile, the other end (upper end in FIG. 1) of the probe is fixed to the force generator 5. Although not illustrated in the drawings, the force generator 5 includes a coil and a permanent magnet surrounding the coil. When an electric current flows through the coil, it is displaced in the axial direction of the probe 10 to generate a force.

A core (iron core) 6b made of a conductor is fixed to the periphery of the probe 10, which is close to the force generator 5, and a differential transformer (primary and secondary coils) 6a is placed around the core 6b. A detector 6c detects the voltage of the differential transformer 6a. When the relative position of the core 6b (i.e., the probe 10) with respect to the differential transformer 6a changes, a voltage is generated in the differential transformer 6a according to the displacement, and the displacement in the axial direction of the core 6b (i.e., the probe 10) can be detected.

The differential transformer 6a, the core 6b, and the detector 6c constitute the “displacement detector”.

A heating furnace composed of a furnace body 12a and a heater 12b arranged around the furnace body 12a is provided around the sample S. The temperature of the furnace is controlled by a furnace controller 14.

The force signal generator 20 generates a force signal to activate the force generator 5. The force signal generator 20 is, for example, an electronic circuit composed of a circuit board and various electronic components and chips mounted on the circuit board.

The force signal generator 20 includes an alternating current (AC) generator (digital signal generator) 21 that generates a digital signal of the force signal, two D/A converters 22a and 22b that convert the digital signals into analog signals, two amplifiers 23a and 23b that amplify the analog signals output from the respective D/A converters 22a and 22b, and a voltage-current converter 24 that converts each of the analog signals (voltages) output from the amplifiers 23a and 23b and outputs the current to the force generator 5.

The AC generator 21 generates a sinusoidal signal (AC signal) that oscillates over time, and this sinusoidal signal (AC signal) is branched and input to the two D/A converters 22a and 22b by which a digital signal is converted to an analog signal (voltage). The generated analog signals are output to the force generator 5 via the voltage-current converter 24 after the amplitudes of the analog signals are adjusted by the respective amplifiers 23a and 23b, and the force generator 5 generates a sinusoidal force (AC force).

The sinusoidal force (AC force) generated by the force generator 5 is applied to the sample S as bending (deflection) stress through the probe 10 and the sample holding member 11. The bending (deflection) strain generated in the sample S by the stress is transmitted to the core 6b through the sample holding member 11 and probe 10, and is detected as the position displacement of the core 6b relative to the differential transformer 6a.

The outputs of the amplifiers 23a and 23b are sent to the load detector 7 via the voltage-current converter 24, and the sinusoidal force (AC force) based on the sinusoidal signal generated by the AC generator 21 is detected.

The displacement detection signal generated by the differential transformer 6b and the core 6a is sent to the displacement detector 6c, and it is converted to a displacement signal.

The load signal, which is the output of the load detector 7, and the displacement signal, which is the output of the displacement detector 8, are sent to an arithmetic unit 9 where physical quantities (mechanical properties) of the sample, such as storage modulus and loss elasticity, are calculated.

Hereinafter, the features of the present disclosure will be described.

In the thermal analyte device 1 of the present disclosure, the force signal generator 20 has two D/A converters 22a and 22b and two amplifiers 23a and 23b that amplify the analog signals output from the respective D/A converters 22a and 22b.

In the present disclosure, the plurality of amplifiers 23a and 23b can amplify each of the analog signals output from the respective D/A converters by different amplification factors. This allows the maximum load that can be applied to the sample to be varied, and different load resolutions can be set without changing the digital resolutions of the D/A converters 22a and 22b.

As a result, it is possible to accurately measure high and low elastic modulus materials.

The amplifier can be set to an arbitrary amplification factor by changing the resistance value, for example, by combining an operational amplifier and two resistors.

In other words, to change the amplification factor, the resistors may be replaced, or variable resistors may be used. However, when the accuracy of the amplification factor is required, non-variable resistors need to be used.

For example, it is assumed that the maximum load that can be applied to the sample S is ±10 N, on the basis of the capability of the force generator 5, etc.

This maximum load is proportional to the current flowing through the coil of the force generator 5 and is also proportional to the analog signals (voltages) amplified by the amplifiers 23a and 23b before the analog signals undergo current conversion through the voltage-current converter 24.

Therefore, by changing the amplification factor of each of the amplifiers 23a and 23b, the signal (current) output to the force generator 5 can be changed, and the maximum load can be changed. Based on the fact that load resolution=maximum load/(digital resolution of the D/A converter), the load resolution can be changed without changing the digital resolution of the D/A converter.

The force signal generator 20 outputs the analog signal amplified by at least one of the plurality of amplifiers 23a and 23b as the force signal. In this case, for example, when the user wishes an analog signal to output from only the amplifier 23a, only the amplifier 23a may be turned on and operated, and the other amplifiers 23b may be turned off according to the user selection that is made through the selection button or control screen.

The method of switching between the amplifiers 23a and 23b is not limited, but the switching may be performed such that the amplifier 23b first outputs a signal and then the amplifier 23a is used only when the load exceeds the maximum load of the amplifier 23b. Alternately, the switching may be performed such that the amplifier 23b is used first, and when he amplifier 23b operates at its maximum load, the same value is output to the amplifier 23a, and the output of the amplifier 23b is set to 0.

Then, when the amplifier 23b reaches the maximum load thereof, the amplifier 23a starts to make an output. This cycle is repeated.

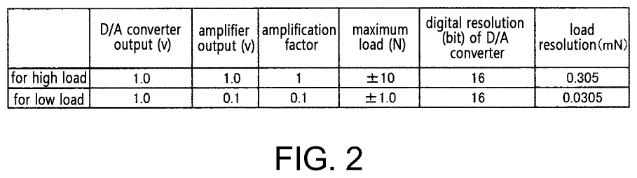

A particular example of changing the maximum load will be described. When that the outputs of the D/A converters 22a and 22b (in this example, the D/A converters are identical) are 1.0 V and the outputs of the amplifiers are 1.0 V (i.e., amplification factor=1) as shown in FIG. 2, the maximum load becomes ±10 N.

Therefore, when the output of the amplifier is changed to 0.1 V (i.e., amplification factor=0.1), the maximum load changes to +1.0 N.

When the digital resolutions of the D/A converters 22a and 22b are 16 bit, the maximum load output from the amplifier 23a with an amplification factor of 1 is +10 N, and the load resolution=20 N (+/−10 N)/16 bit=20 N/(2¹⁶)=0.305 mN.

On the other hand, since the maximum load output from the amplifier 23b with an amplification factor of 0.1 is +1.0 N, the load resolution=2 N (+/−1 N)/16 bit=20 N/(2¹⁶)=0.0305 mN.

Therefore, a single thermal analysis device can realize both a high-load mode with a high maximum load of +10 N and a low-load mode with a low maximum load of +1 N and an excellent load resolution.

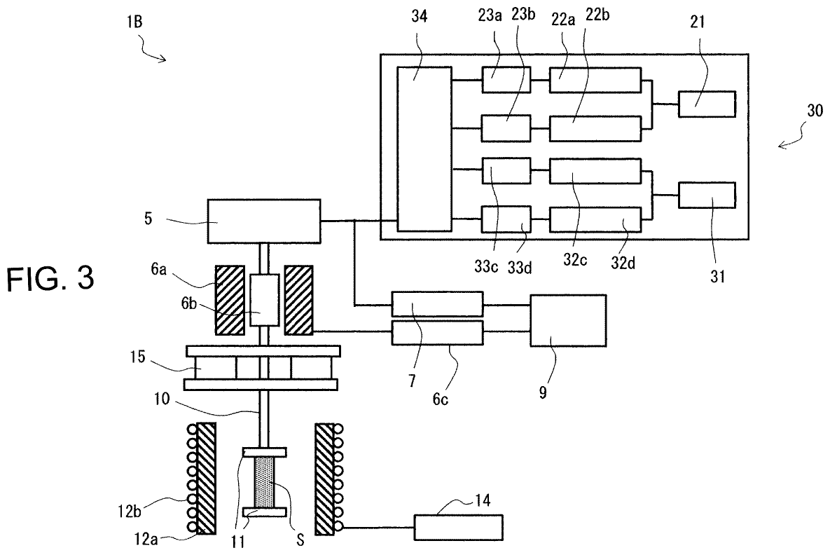

Next, with reference to FIG. 3, a thermal analysis device (dynamic viscoelasticity measurement (DMA) device)

1B according to a second embodiment of the present disclosure will be described. FIG. 3 is a view illustrating the construction of the thermal analysis device 1B.

The thermal analysis device 1B is identical to the thermal analysis device 1 of the first embodiment except for the configuration described below.

In the thermal analysis device 1B of the present disclosure, the force signal generator 30 includes an AC generator 21, two D/A converters 21a and 22b, and two amplifiers 23a and 23b as in the thermal analysis device 1.

In addition, the force signal generator 30 includes an direct current (DC) generator (digital signal generator) 31 that generates a digital signal of the force signal, two D/A converters 32c and 32d that convert the digital signals into analog signals, two amplifiers 33c and 33d that amplify the analog signals output from the respective D/A converters 32c and 32d, and a voltage-current converter 34 that converts each of the analog signals (voltages) output from the amplifiers 23a, 23b, 33c, and 33d and outputs the current to the force generator 5.

When a soft sample such as a film is measured with a dynamic viscoelasticity measurement device, a DC force that is constant over time is applied to the sample as a tension to prevent the film-like sample from sagging and to maintain the sample shape. The DC generator 31 generates this tension.

In this way, as in the first embodiment, due to the two amplifiers 23a and 23b that operate on the basis of the output of AC generator 21, a high load mode with a high maximum load and a low load mode with a low maximum load and an excellent load resolution can be realized in a single thermal analysis device.

In addition, due to the two amplifiers 33c and 33d that operate on the basis of the output of the DC generator 31, it is possible to apply tension to the sample in each of the high and low load modes, allowing measurements while the sample shape is maintained although the load changes from high to low.

From the viewpoint of applying tension to the sample in each of the high and low load modes, it is preferable that the difference between the amplification factors of the two amplifiers 33c and 33d be the same as that of the amplifiers 23a and 23b because higher tension (DC force) is required in the high load mode.

For example, in FIG. 2, the difference between the amplification factors of the amplifiers 23a and 23b is 10 times in the high and low load modes. The difference between the amplification factors of the amplifiers 33c and 33d in the high and low load modes also needs to be 10 times.

For example, in the high load mode, the voltage-current converter 34 combines the sinusoidal signal (voltage, which is an AC signal) output from the amplifier 23a and the DC signal (voltage) output from the amplifier 33C, converts the combined signal into a current, and outputs the current.

In this case, for example, when the user selects the high load mode on the selection button or control screen, each of the amplifiers may be turned on and off so that only the amplifiers 23a and 33c can be operated.

The present disclosure is not limited to the above embodiments.

For example, the present disclosure can be applied to a thermomechanical analysis (TMA) device by replacing the AC generator 21 in the first embodiment with a DC generator.

The number of D/A converters and the number of corresponding amplifiers may be two or more.

One end of the probe may be in direct contact with the sample to apply load to the sample.

The difference in amplification factor of each of the plurality of amplifiers is preferably about 10 times, but it is satisfactory if the difference is at least 2 times.

The D/A converters may be identical or different from each other. The digital resolution of each of the D/A converters may have the same or different.

One digital signal generator, such as an AC generator or DC power generator, should be provided for a plurality of D/A converters that is to output a specific type of digital signal, such as AC or DC. For example, when AC generators are provided for respective D/A converters, the cost will increase, and the AC phases of the D/A converters may not match.

AC signals include sine waves, square waves, and triangular waves.

“At least one of the plurality of amplifiers” may be one, two, or all of the amplifiers.

What is claimed is:

1. A thermal analysis device comprising:
a probe that extends in an axial direction, one end side of the probe contacting a sample directly or indirectly to apply a load to the sample;
a force generator provided at another end side of the probe and configured to generate a force in the axial direction of the probe;
a displacement detector that detects a displacement in the axial direction of the probe to measure a mechanical property of the sample;
a force signal generator that generates a force signal to activate the force generator;
a load detector that detects a load applied to the sample; and
a furnace for heating the sample;
wherein the force signal generator comprises a digital signal generator that generates a digital signal of the force signal, a plurality of D/A converters that convert the digital signal into an analog signal, and a plurality of amplifiers that amplify the analog signal output from each of the plurality of D/A converters by different amplification factors, respectively; and
the force signal generator outputs the analog signal amplified by at least one of the plurality of amplifiers as the force signal.

2. The thermal analysis device according to claim 1, wherein a difference in the amplification factor of each of the plurality of amplifiers is greater than or equal to 2 times.

3. The thermal analysis device according to claim 1, wherein the thermal analysis device comprises a plurality of digital signal generators, each of which generating a different digital signal, and comprises a plurality of the D/A converters and a plurality of the amplifiers for each of the plurality of digital signal generators.

4. The thermal analysis device according to claim 2, wherein the thermal analysis device comprises a plurality of digital signal generators, each of which generating a different digital signal, and comprises a plurality of the D/A converters and a plurality of the amplifiers for each of the plurality of digital signal generators.

5. thermal analysis device according to claim of 3, wherein the different digital signals comprise an AC signal that oscillates over time and a DC signal that is constant over time.

6. thermal analysis device according to claim of 4, wherein the different digital signals comprise an AC signal that oscillates over time and a DC signal that is constant over time.
